(19) United States
(12) Patent Application Publication
(10) Pub. No.: US 2025/0070122 A1
(43) Pub. Date: Feb. 27, 2025

(54) ANODE FOR LITHIUM SECONDARY BATTERY AND LITHIUM SECONDARY BATTERY INCLUDING THE SAME

(71) Applicant: SK On Co., Ltd., Seoul (KR)

(72) Inventors: Hyo Mi KIM, Daejeon (KR); Seong Cho KWON, Daejeon (KR); Moon Sung KIM, Daejeon (KR); Sang Baek RYU, Daejeon (KR); Da Hye PARK, Daejeon (KR); Sang Won PARK, Daejeon (KR); Sang In BANG, Daejeon (KR); Seung Hyun YOOK, Daejeon (KR); Hwan Ho JANG, Daejeon (KR); Da Bin CHUNG, Daejeon (KR); Jun Hee HAN, Daejeon (KR)

(21) Appl. No.: 18/801,855

(22) Filed: Aug. 13, 2024

(30) Foreign Application Priority Data
Aug. 25, 2023 (KR) 10-2023-0111788

(51) Int. Cl. H01M 4/133; C01B 32/956; C01B 33/113; H01M 4/02; H01M 4/62

(52) U.S. Cl. CPC H01M 4/133; C01B 32/956; C01B 33/113; H01M 4/625; C01P 2002/82; C01P 2004/61; C01P 2006/40; H01M 2004/027

(57) ABSTRACT

An anode for a secondary battery is provided, the anode for a secondary battery including: an anode current collector; a first anode mixture layer formed on at least one surface of the anode current collector, and including a first silicon-based active material and a first conductive material; and a second anode mixture layer formed on the first anode mixture layer, and including a second silicon-based active material and a second conductive material, wherein a content of the first silicon-based active material in the first anode mixture layer is lower than a content of the second silicon-based active material in the second anode mixture layer, and a Radial Breathing Mode (RBM) peak is observed in a Raman spectrum obtained from a surface of the second anode mixture layer.

### CROSS-REFERENCE TO RELATED APPLICATION(S)

This patent document claims the priority and benefits of Korean Patent Application No. 10-2023-0111788 filed on Aug. 25, 2023, the disclosure of which is incorporated herein by reference in its entirety.

### TECHNICAL FIELD

The technology and implementations disclosed in this patent document relate to an anode for a lithium secondary battery and a lithium secondary battery including the same.

### BACKGROUND

As a large amount of research is being conducted on electric vehicles (EVs) that can replace vehicles using fossil fuels such as gasoline vehicles, diesel vehicles, and the like, which are one of the main causes of air pollution, and lithium secondary batteries with high discharge voltage and output stability are mainly used as a power source for such electric vehicles (EVs). Accordingly, the need for lithium secondary batteries with high energy density is increasing, and development and research of high-capacity anodes for these are also actively being conducted.

In order to implement secondary batteries having a high capacity and high energy density, the development of applying a silicon-based active material having a higher discharge capacity as compared to graphite to an anode for a secondary battery is being actively undertaken. When a silicon-based active material having a relatively high discharge capacity is applied as an active material for the anode for a secondary battery, a loading weight (LW) of an anode active material layer may also be lowered, thereby further increasing energy density.

However, when a silicon-based active material is applied, problems such as (1) increased resistance due to a side reaction with an electrolyte solution, and (2) internal short circuits or active material cracking due to relatively high volumetric contraction/expansion rates during charging/discharging, may occur, so there may be a difference in securing lifespan characteristics, fast charging performance, and the like of an anode containing a silicon-based active material, at an excellent level. Accordingly, there is demand for the development of an anode for a secondary battery having excellent capacitance characteristics, lifespan characteristics, and fast charging characteristics.

### SUMMARY

An aspect of the disclosed technology is to provide an anode for a secondary battery that can reduce the expansion/contraction of the volume of a silicon-based active material during charging/discharging of the battery, thereby alleviating the occurrence of active material cracking.

Another aspect of the disclosed technology is to provide an anode for a secondary battery having excellent lifespan, rapid charging, and capacity characteristics in room temperature and high temperature environments.

In an aspect of the disclosed technology, an anode for a secondary battery is provided, the anode for a secondary battery including: an anode current collector, a first anode mixture layer formed on at least one surface of the anode current collector, and including a first silicon-based active material and a first conductive material, and a second anode mixture layer formed on the first anode mixture layer, and including a second silicon-based active material and a second conductive material, wherein a content of the first silicon-based active material in the first anode mixture layer may be lower than a content of the second silicon-based active material in the second anode mixture layer, and a radial breathing mode (RBM) peak may be observed in a Raman spectrum obtained from a surface of the second anode mixture layer.

G-band splitting may be observed in the Raman spectrum obtained from the surface of the second anode mixture layer.

The first silicon-based active material and the second silicon-based active material may include at least one of SiOₓ (0<x<2) and SiC, respectively.

The content of the first silicon-based active material in the first anode mixture layer may be 0.1 to 5% by weight.

The content of the second silicon-based active material in the second anode mixture layer may be 6 to 35% by weight.

The first conductive material may include a graphite-based conductive material, and the second conductive material may include a CNT-based conductive material.

The first conductive material may be any one selected from artificial graphite, natural graphite, graphene, carbon black, acetylene black, Ketjen black, Super P, hard carbon, and combinations thereof.

The second conductive material may be any one selected from multi-walled carbon nanotubes (MWCNT), single-walled carbon nanotubes (SWCNT), thin-film carbon nanotubes (TWCNT), and combinations thereof.

A content of the first conductive material in the first anode mixture layer may be higher than a content of the second conductive material in the second anode mixture layer.

The content of the first conductive material in the first anode mixture layer may be 0.3 to 5% by weight.

The content of the second conductive material in the second anode mixture layer may be 0.01 to 0.25% by weight.

A particle diameter (D50) of the first conductive material may be 1 to 10 μm.

A length of the second conductive material may be 5 to 100 μm.

In an aspect of the disclosed technology, an anode for a secondary battery is provided, the anode for a secondary battery including: an anode current collector, a first anode mixture layer formed on at least one surface of the anode current collector, and including a first silicon-based active material and a first conductive material, and a second anode mixture layer formed on the first anode mixture layer, and including a second silicon-based active material and a second conductive material, wherein a content of the first silicon-based active material in the first anode current mixture layer may be lower than a content of the second silicon-based active material in the second anode mixture layer, and the first conductive material may have a Raman R value according to Equation 1 below which is greater than that of the second conductive material.

$$Raman R = {A}_{D} / {A}_{G} \qquad [ Equation 1 ]$$

In Equation 1, A_{D} is a peak area value of an absorption region of 1330 to 1380 cm⁻¹, and A_{G} is a peak area value of an absorption region of 1550 to 1625 cm⁻¹.

The content of the first silicon-based active material in the first anode mixture layer may be 0.1 to 5% by weight.

The content of the second silicon-based active material in the second anode mixture layer may be 6 to 35% by weight.

The Raman R value of the first conductive material may be 0.11 to 0.5.

The Raman R value of the second conductive material may be 0.001 to 0.1.

The first conductive material may be any one selected from artificial graphite, natural graphite, graphene, carbon black, acetylene black, Ketjen black, Super P, hard carbon, and combinations thereof.

The second conductive material may be any one selected from multi-walled carbon nanotubes (MWCNT), single-walled carbon nanotubes (SWCNT), thin-film carbon nanotubes (TWCNT), and combinations thereof.

A content of the first conductive material in the first anode mixture layer may be higher than a content of the second conductive material in the second anode mixture layer.

A lithium secondary battery according to the present disclosure may include the anode.

### BRIEF DESCRIPTION OF DRAWINGS

The above and other aspects, features and other advantages of the disclosed technology will be more clearly understood through the following detailed description, with reference to the accompanying drawings.

FIG. 1 is a schematic cross-sectional view illustrating a structure of an anode for a lithium secondary battery according to an embodiment.

FIGS. 2A and 2B are diagrams illustrating the results of Raman spectroscopy analysis of a first conductive material and a second conductive material included in the anode for a secondary battery according to an embodiment, respectively.

FIG. 3A is a diagram illustrating the results of Raman spectroscopy analysis of the anode for a lithium secondary battery according to Reference Example 1.

FIG. 3B is an enlarged view of a G-band portion in FIG. 3A.

FIG. 3C is an enlarged view of a RBM peak portion in FIG. 3A.

FIG. 4 is a diagram illustrating the results of Raman spectroscopy analysis of the anode for a lithium secondary battery according to Reference Example 2.

### DETAILED DESCRIPTION

The disclosed technology relates to an anode including a silicon-based anode active material, and the disclosed technology will be described in detail with reference to the accompanying drawings.

As described above, a silicon-based active material may be applied as an anode active material to achieve high capacity characteristics of an anode for a secondary battery, but there is a need for an anode design that can alleviate problems caused by (1) increased resistance due to a side reaction with an electrolyte and (2) relatively high volumetric contraction/expansion rates during charging/discharging.

Accordingly, the inventors have confirmed that, when the characteristics of a silicon-based active material, a conductive material, and the like, are applied differently in consideration of the characteristics required for each upper and lower layer in an anode having a multilayer structure, a high-energy density anode for a secondary battery having excellent lifespan characteristics and improved capacitance characteristics may be provided by reducing the expansion/contraction of the volume of the anode including a silicon-based active material.

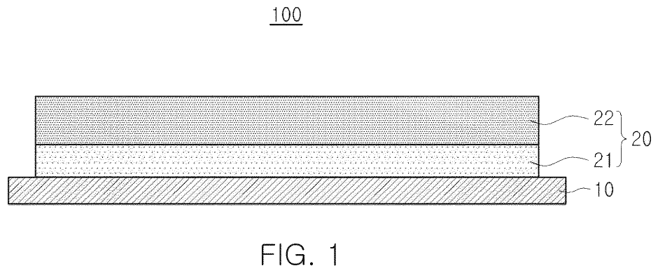

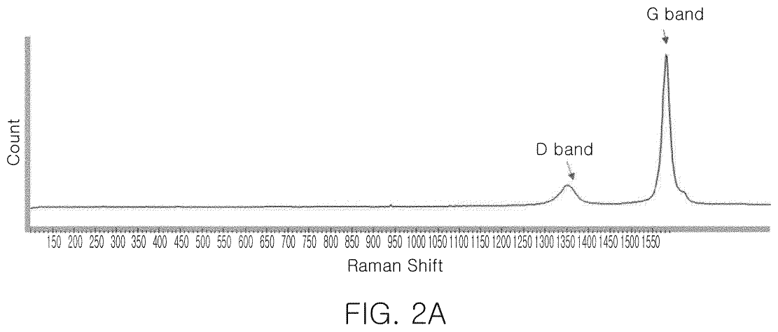

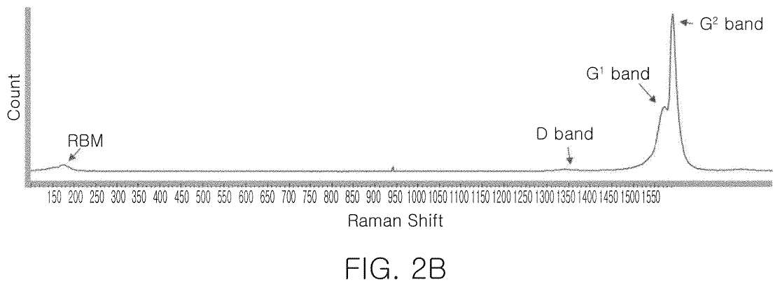

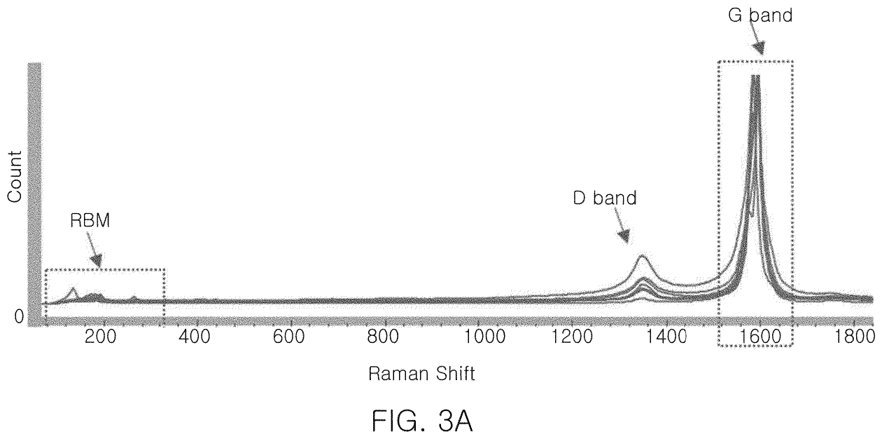

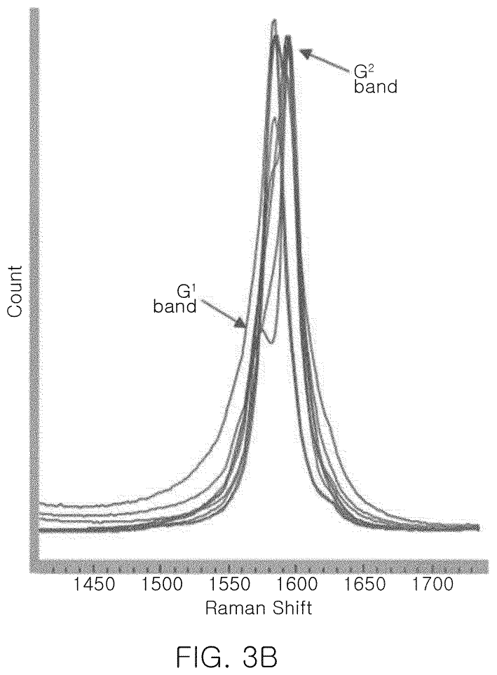

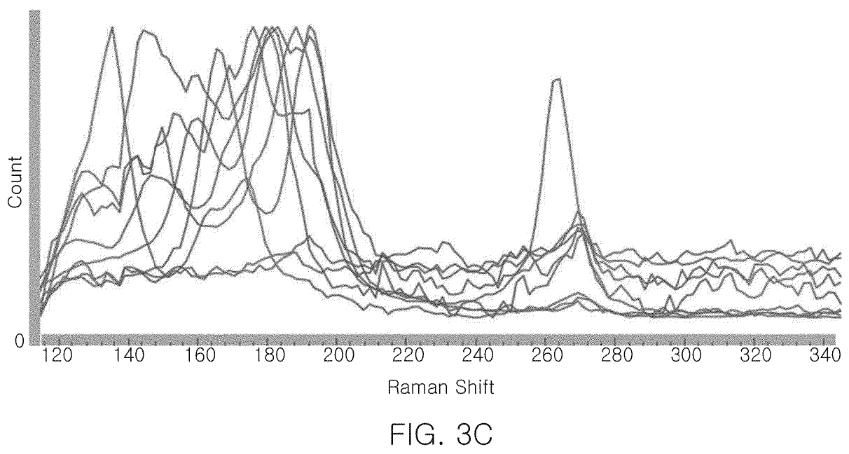

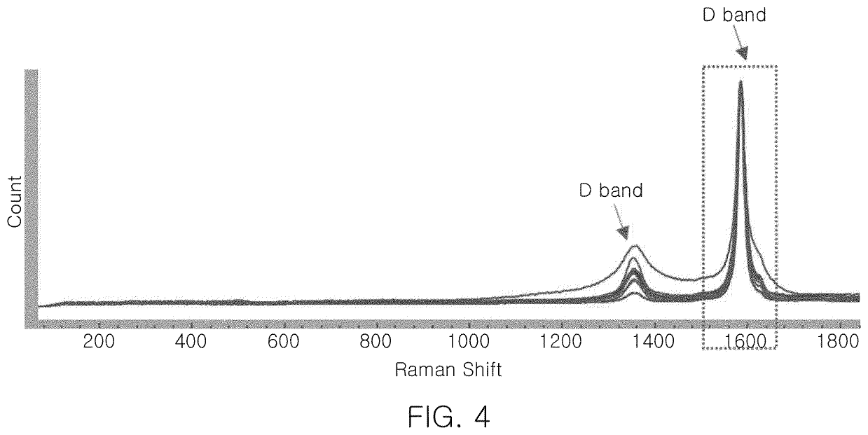

Embodiments of the present disclosure are described in detail hereinafter, with respect to FIGS. 1 to 4. FIG. 1 is a schematic cross-sectional view illustrating a structure of an anode for a secondary battery according to an embodiment, FIGS. 2A and 2B are diagrams illustrating results of Raman spectroscopy analysis of first and second conductive materials included in an anode for a secondary battery according to an embodiment, respectively, FIG. 3A is a diagram illustrating results of Raman spectroscopy analysis of an anode for a lithium secondary battery according to Reference Example 1 and FIG. 3B is an enlarged view of a G-band portion in FIG. 3A, FIG. 3C is an enlarged view of a RBM peak portion in FIG. 3, and FIG. 4 is a diagram illustrating results of Raman spectroscopy analysis of an anode for a lithium secondary battery according to Reference Example 2.

### Anode for Lithium Secondary Battery

Referring to FIG. 1, an anode for a lithium secondary battery 100 according to an embodiment of the present disclosure may include an anode current collector 10, a first anode mixture layer 21 formed on at one surface of the anode current collector 10, and including a first silicon-based active material and a first conductive material, and a second anode mixture layer 22 formed on the first anode mixture layer 21, and including a second silicon-based active material and a second conductive material.

In this case, the first anode mixture layer 21 is an anode mixture layer (lower layer) on one surface adjacent to the anode current collector 10, and the second anode mixture layer 22 is an anode mixture layer (upper layer) formed on the first anode mixture layer 21 and relatively spaced apart from the anode current collector 10.

The anode current collector 10 may include a metal having excellent conductivity and excellent adhesion to an anode slurry. For example, as the anode current collector 10, any one selected from the group consisting of copper foil, nickel foil, stainless steel foil, titanium foil, nickel foam, copper foam, a polymer substrate coated with a conductive metal, and combinations thereof may be appropriately used.

Each of the first silicon-based active material and the second silicon-based active material is an element selected from the group consisting of Si, SiOx (0<x<2), Si-Q alloy, where Q is an alkali metal, an alkaline earth metal, a Group 13 element, a Group 14 element, a Group 15 element, a Group 16 element, a transition metal, a rare earth element, and combinations thereof and is not Si, and SiC. Specifically, each of the first silicon-based active material and the second silicon-based active material may include at least one of SiOx (0<x<2) and SiC.

A content of the first silicon-based active material in the first anode mixture layer 21 may be lower than a content of the second silicon-based active material in the second anode mixture layer 22. By controlling the content of the silicon-based active material (the first silicon-based active material) included in the first anode mixture layer 21 adjacent to the anode current collector 10 to be low as compared to the content of the silicon-based active material (the second silicon-based active material) included in the second anode mixture layer 22, the anode for a lithium secondary battery 100 may more effectively prevent delamination of an anode and short-circuit phenomenon due to a change in the volume of the silicon-based active material during charging/discharging of the secondary batteries, and maintain the content of the silicon-based active material as a whole at an appropriate level or higher to secure capacitance characteristics. Specifically, the content of the first silicon-based active material in the first anode mixture layer may be about 0.1 to about 5% by weight, specifically, about 1 to about 4% by weight, and the content of the second silicon-based active material in the second anode mixture layer may be about 6 to about 35% by weight, specifically, about 10 to about 20% by weight.

The total content of the silicon-based active material in the anode mixture layer 20 (i.e., the total content of the first silicon-based active material and the second silicon-based active material based on the entire anode mixture layer 20) may be about 0.1 to about 20% by weight. Specifically, the content of the silicon-based active material in the anode mixture layer 20 may be about 1% by weight or more, about 5% by weight or more, or about 7% by weight or more, and may be about 20% by weight or less, about 15% by weight or less, or about 13% by weight or less.

In an embodiment, the first anode mixture layer 21 may include only the first silicon-based active material, and the second anode mixture layer 22 may include only the second silicon-based active material. However, in another embodiment, the first anode mixture layer 21 and the second anode mixture layer 22 may include both the first silicon-based active material and the second silicon-based active material, described above, respectively. In this case, the content of the first silicon-based active material in the first negative electrode mixture layer 21 may be higher than the content of the second silicon-based active material, and the content of the second silicon-based active material in the second anode mixture layer 22 may be higher than the content of the first silicon-based active material.

The first anode mixture layer 21 and the second anode mixture layer 22 may further include a carbon-based active material, respectively. The carbon-based active material may be a carbon-based material of at least one selected from artificial graphite, natural graphite, hard carbon, soft carbon, carbon black, acetylene black, Ketjen black, Super P, graphene, and fibrous carbon, and may be specifically, artificial graphite or natural graphite. A content ratio of artificial graphite and natural graphite in the first anode mixture layer 21 and a content ratio of artificial graphite and natural graphite in the second anode mixture layer 22 may be about 5:5 to about 9:1, respectively. When each of the first anode mixture layer 21 and the second anode mixture layer 22 further includes a carbon-based active material, each of the content of the carbon-based active material in the first anode mixture layer 21 and the content of the carbon-based active material in the second anode mixture layer 22 may be, for example, about 80 to about 99% by weight, or about 85 to about 95% by weight.

Each of the first anode mixture layer 21 and the second anode mixture layer 22 may further include a conductive material. Specifically, the first anode mixture layer 21 may include the first conductive material, and the second anode mixture layer 22 may include the second conductive material. The conductive material is used to provide conductivity to an electrode and maintain a structure of the electrode, and a conductive material without causing a side reactions with other elements of the secondary battery and having conductivity may be used as the conductive material. According to an embodiment, by applying different types of conductive materials for each of an upper and a lower layer in the anode mixture layer 20 having a multilayer structure, an anode for a secondary battery with better capacitance characteristics, lifespan characteristics, and the like, may be provided.

The first conductive material may have a Raman R value according to Equation 1 below that is greater than that of the second conductive material.

$$Raman R = {A}_{D} / {A}_{G} \qquad [ Equation 1 ]$$

In Equation 1, A_{D} is a peak area value of an absorption region of 1330 to 1380 cm⁻¹, and A_{G} is a peak area value of an absorption region of 1550 to 1625 cm⁻¹.

The Raman R value is a parameter representing relative crystallinity of the material, the A_{D} value represents a peak area of a region related to an amorphous state, and the A_{G} value represents a peak area of a region related to a crystalline state. Therefore, the greater the Raman R value, the relatively lower the crystallinity of the material, and the smaller the Raman R value, the relatively greater the crystallinity of the material.

The peak area can be calculated by integrating an area of the absorption region in which the peak is observed by Raman spectroscopy. Specifically, the peak area may be calculated using a Resolutions Pro program, and may be calculated by deriving a baseline using a 2nd derivative method, and then integrating an area derived by firing a peak corresponding to a wave number of each region with a Gaussian curve. In this case, Raman spectroscopic analysis may be performed under the following conditions: wavelength: 532 nm, magnification: 50 times, grating resolution: 1800 mm/l, laser power: 5%, and the number of scans: 10.

A Raman R value of the first conductive material may be about 0.11 to about 0.5, and a Raman R value of the second conductive material may be about 0.001 to about 0.1. Specifically, the Raman R value of the first conductive material may be about 0.11 or more or about 0.13 or more, and about 0.3 or less or about 0.2 or less. In addition, the Raman R value of the second conductive material may be about 0.005 or more, about 0.01 or more, or about 0.03 or more, and may be about 0.09 or less. When applying the Raman R values of the first and second conductive materials as described above, a conductive material with relatively low crystallinity is applied to the first anode mixture layer 21 adjacent to the anode current collector 10 may be included, so that a problem such as electrode detachment due to volume expansion of a silicon-based active material may be substantially alleviated. In addition, a conductive material with high crystallinity and excellent conductivity and dispersibility may be included in the second anode mixture layer 22, having a relatively low energy density, so that a conductive path within an electrode layer may be formed and maintained, thereby further improving fast charging characteristics.

The first conductive material is a conductive material that can alleviate the occurrence of side reactions with an electrolyte due to relatively small reactivity and specific surface area with the electrolyte, and refers to a conductive material included in the first anode mixture layer 21, which is a lower layer. The second conductive material is a conductive material having relatively excellent dispersibility and conductivity, forming a conductive path that can increase electrical contact between each component, so that a phenomenon in which an electrical network is disconnected may be minimized and an increase in resistance may be alleviated even if the volume of the silicon-based active material changes during battery charging/discharging, and refers to a conductive material included in the second anode mixture layer 22, which is an upper layer.

The first conductive material may include a graphite-based conductive material, and the second conductive material may include a CNT-based conductive material.

Specifically, the first conductive material may be any one selected from artificial graphite, natural graphite, graphene, carbon black, acetylene black, Ketjen black, Super P, hard carbon, and combinations thereof, and the second conductive material may be any one selected from multi-walled carbon nanotubes (MWCNT), single-walled carbon nanotubes (SWCNT), thin-film carbon nanotubes (TWCNT), and combinations thereof.

More specifically, the first conductive material may be any one graphite-based conductive material selected from artificial graphite, natural graphite, and combinations thereof. When a graphite-based conductive material, which is a carbon-based active material and an anode active material, is applied as the first conductive material, the occurrence of side reactions with an electrolyte may be alleviated to reduce electrolyte consumption, and it may also contribute to further improving the capacitance characteristics of the anode 100. In addition, when a CNT-based conductive material such as single-walled carbon nanotube (SWCNT) is applied as the second conductive material, a conductive path that can increase electrical contact between components included in the anode mixture layer 20 may be more easily formed, so that the effect of changes of the volume of the silicon-based active material during battery charging/discharging may be minimized, and an increase in resistance may be further alleviated.

In addition, the anode for a lithium secondary battery 100 may exhibit a Radial Breathing Mode (RBM) peak in a Raman spectrum obtained from a surface the second anode mixture layer 22. In this case, the RBM peak may not substantially be observed in the Raman spectrum obtained from the surface of the first anode mixture layer 21. In addition, the anode for a lithium secondary battery 100 may exhibit G-band splitting in the Raman spectrum obtained from the surface of the second anode mixture layer 22. In this case, G-band splitting may not be substantially observed in the Raman spectrum obtained from the surface of the first anode mixture layer 21. Whether the RBM peak and G-band splitting are observed during Raman spectroscopy analysis of the anode mixture layer 20 may vary depending on the type of component included in the anode mixture layer 20, specifically, the type of conductive material.

The RBM peak is a peak which is observed in a low wavenumber region of about 100 to about 500 cm⁻¹, specifically, about 100 to about 350 cm⁻¹, in the Raman spectrum. The RBM peak may be observed in various low wavenumber regions, such as about 180 cm⁻¹, about 190 cm⁻¹, and about 270 cm⁻¹. Whether the RBM peak is observed may be determined by a ratio (A_{RBM}/A_{G}) between an area of the RBM peak region (A_{RBM}) and an area of the G-band peak region (A_{G}). Specifically, when the A_{RBM}/A_{G} value is about 0.03 to about 0.06, it may be determined that the RBM peak is observed, and when the A_{RBM}/A_{G} value is about 0.001 to about 0.02, it may be determined that the RBM peak is not observed.

The area of the RBM peak region (A_{RBM}) and the area of the G-band peak region (A_{G}) may be calculated using the Resolutions Pro program. In this case, the area (A_{RBM}) of the RMB peak region may be calculated by deriving a base line using a 2^{nd} derivative method, and then integrating an area derived by fitting a peak corresponding to a wave number of about 106 cm⁻¹, about 123 cm⁻¹, and about 201 to about 234 cm⁻¹, with a Gaussian curve, and the area (A_{G}) of the G-band peak region may be calculated using the same method as described above for a peak corresponding to a wave number of about 1215 cm⁻¹, about 1565 cm⁻¹, and about 1600 to 1745 cm⁻¹. In this case, Raman spectroscopic analysis may be performed under the following conditions: wavelength: 532 nm, magnification: 50 times, grating resolution: 1800 mm/l, laser power: 5%, and the number of scans: 10.

The G-band is a portion in which a peak is observed in the absorption region of about 1550 to about 1625 cm⁻¹ during Raman spectroscopy analysis, and G-band splitting means that the G-band described above is observed as a multiple or complex peak due to two components. Specifically, the G-band splitting may mean that both a G¹-band having a peak in an absorption region of about 1568 to about 1586 cm⁻¹ during Raman spectroscopy analysis and a G²-band having a peak in the absorption region of about 1587 to about 1595 cm⁻¹, are observed.

Raman spectroscopic analysis of the surface of the anode mixture layer 20 may be performed on 10 or more points (for example, 10 to 5,000 points), and as the number of points increases, it may be determined that the reliability is high. In addition, in the case of the anode 100 having a multilayer structure, when Raman spectroscopic analysis is performed on the surface of the first anode mixture layer 21, Raman spectroscopic analysis may be performed on a point included in a region adjacent to the anode current collector 10 (for example, a region from the anode current collector 10 to a thickness of about 0.1 to about 20% of the total thickness of the anode mixture layer 20 in a thickness direction of the anode mixture layer 20), and when Raman spectroscopic analysis is performed on the surface of the second anode mixture layer 22, Raman spectroscopic analysis may be performed on a point included in a region spaced apart from the anode current collector 10 (for example, a region from an outermost surface of the anode mixture layer 20 to a thickness of about 0.1 to about 10% of the total thickness of the anode mixture layer 20 in a thickness direction of the anode mixture layer 20). In this case, Raman spectroscopic analysis may be performed under the following conditions: wavelength: 532 nm, magnification: 50 times, grating resolution: 1800 mm/l, laser power: 5%, and the number of scans: 10.

Referring to FIGS. 2A and 2B, when Raman spectroscopy analysis of the first conductive material (graphite-based conductive material) included in the anode for a secondary battery according to an embodiment, neither the RBM peak nor the G-band splitting may be not observed (see FIG. 2A), and when Raman spectroscopy analysis of the second conductive material (CNT-based conductive material), it can be confirmed that both the RBM peak and G-band splitting are observed. Referring to FIGS. 2A and 2B, when Raman spectroscopy analysis of the first conductive material (graphite-based conductive material) included in the anode for a secondary battery according to an embodiment, neither the RBM peak nor the G-band splitting may not be observed (see FIG. 2A), and when Raman spectroscopy analysis of the second conductive material (CNT-based conductive material), it can be confirmed that both the RBM peak and G-band splitting are observed.

As described above, whether the RBM peak and G-band splitting are observed when Raman spectroscopy analysis of an anode mixture layer may vary depending on the type of conductive material included in the anode mixture layer, and when different types of conductive material are applied for each upper and lower layer in an anode having a multilayer structure, when Raman spectroscopy analysis of the surface of the upper and lower anode mixture layers, whether RBM peaks and G-band splitting are observed may differ. Therefore, as described above, when an RBM peak, or the like, is observed in the Raman spectrum obtained from the surface of the second anode mixture layer 22, a Radial Breathing Mode (RBM) peak, and the like, are not observed, it can be determined that the first anode mixture layer 21 includes the first conductive material, and the second anode mixture layer 22 includes the second conductive material.

When different types of conductive materials are applied appropriately for each upper/lower layer in an anode having a multilayer structure, so whether the RBM peak, or the like, is observed is different for each upper and lower layer, a conductive material having relatively low crystallinity may be included in the first anode mixture layer 21 adjacent to the anode current collector 10, so that a problem such as electrode detachment due to volume expansion of the silicon-based active material may be substantially alleviated. In addition, a conductive material having high crystallinity and excellent conductivity and dispersibility may be included in the second anode mixture layer 22, having relatively low energy density, so that a conductive path in the electrode layer may be formed and maintained, thereby further improving fast charging characteristics.

A particle diameter (D50) of the first conductive material may be about 1 to about 10 μm, and a length of the second conductive material may be about 5 to about 100 μm. Specifically, the particle diameter (D50) of the first conductive material may be about 2 to about 7 μm. In addition, the particle diameter (D50) of the second conductive material may be about 1 to about 15 nm. The particle diameter (D50) refers to an average particle diameter based on 50% of the particle diameter distribution, and may be measured and calculated using a typical particle diameter measuring device (e.g., Microtrac MT 3000) and method.

A content of the first conductive material in the anode mixture layer 21 may be higher than a content of the second conductive material in the second anode mixture layer 22. Specifically, the content of the first conductive material in the first anode mixture layer 21 may be about 0.3 to about 5% by weight, and the content of the second conductive material in the second anode mixture layer 22 may be about 0.01 to about 0.25% by weight. More specifically, the content of the first conductive material in the first anode mixture layer 21 may be about 0.3 to about 3% by weight, about 0.35 to about 1% by weight, or about 0.4 to about 0.6% by weight, and the content of the second conductive material in the second anode mixture layer 22 may be about 0.05 to about 0.15% by weight. When the contents of the first conductive material and the second conductive material are adjusted within the above-described range, the content of the conductive material included in the first anode mixture layer 21 formed on one surface adjacent to the anode current collector 10 may be adjusted to be relatively high, so that a contact point between the anode current collector 10 and the first anode mixture layer 21 may increase. When such a contact point increases, resistance between the anode 100 and the anode current collector 10 may be reduced, and even if the anode 100 expands during usage, the contact point between the anode current collector 10 and the anode 100 may be maintained. In addition, by adjusting the content of the second conductive material included in the second anode mixture layer 22 to be relatively low, the content of the conductive material included in the entire anode 100 may be reduced so that economic feasibility may be secured, and by increasing a content of the active material in the anode mixture layer 20, an anode 100 having the same energy density with a relatively low loading weight may be implemented. In addition, when an excessive amount of conductive material is included in the upper layer, the problem of deterioration of the interface resistance and lifespan characteristics of the cathode 100 by blocking pores may be alleviated.

In an embodiment, the first anode mixture layer 21 may include only the first conductive material as a conductive material, and the second anode mixture layer 22 may include only the second conductive material as a conductive material. However, in another embodiment, the first anode mixture layer 21 and the second mixture layer 22 may respectively include both the first conductive material and the second conductive material. In this case, the content of the first conductive material in the first anode mixture layer 21 may be higher than the content of the second conductive material, and the content of the second conductive material in the second negative electrode mixture layer 22 may be higher than that of the first conductive material.

The first anode mixture layer 21 and the second anode mixture layer 22 may respectively further include an additional conductive material. As an example, the additional conductive material may include metal powder particles or metal fibers such as copper, nickel, aluminum, and silver; conductive whiskers such as zinc oxide and potassium titanate; conductive metal oxides such as titanium oxide; or conductive polymers such as polyphenylene derivatives, singly or in combination of two or more thereof.

The first anode mixture layer 21 and the second anode mixture layer 22 may respectively further include a binder. The binder is not particularly limited as long as it is a compound that serves to well adhere the components in the anode electrode mixture layer 20 to each other and the anode electrode mixture layer 20 to the anode electrode current collector 10. Examples of the rubber-based binders may include a rubber-based binder such as styrene-butadiene rubber (SBR), fluorine-based rubber, ethylene propylene rubber, butadiene rubber, isoprene rubber, silane-based rubber, and the like; a cellulose-based binder such as carboxymethylcellulose (CMC), hydroxypropylmethylcellulose, methylcellulose, or alkali metal salts thereof; and a combination thereof. Specifically, the first anode mixture layer 21 and the second anode mixture layer 22 may respectively include a rubber-based binder, and more specifically, the first anode mixture layer 21 and the second anode mixture layer 22 may respectively include a rubber-based binder and a cellulose-based binder.

When the first anode mixture layer 21 and the second anode mixture layer 22 respectively further include a binder, a content of the binder in the first anode mixture layer 21 and the content of the binder in the second anode mixture layer 22 may respectively be, exemplarily, about 0.1 to about 10% by weight.

In an embodiment, when the first anode mixture layer 21 and the second anode mixture layer 22 respectively further include a rubber-based binder, a content of the rubber-based binder in the first anode mixture layer 21 may be greater than or equal to the content of the rubber-based binder in the second anode mixture layer 22. Specifically, the content of the rubber-based binder in the first anode mixture layer 21 may be about 1.0 to about 3% by weight, and the content of the rubber-based binder in the second anode mixture layer 22 may be about 0.1 to about 1.0% by weight. More specifically, the content of the rubber-based binder in the first anode mixture layer 21 may be about 1.5 to about 2.5% by weight, and the content of the rubber-based binder in the second anode mixture layer 22 may be about 0.4 to about 0.8% by weight.

When the content of the rubber-based binder in the first negative electrode mixture layer 21 is too low, adhesion of the first anode mixture layer 21 adjacent to the anode current collector 10 may decrease, causing a problem such as scrap generation and detachment of the anode mixture layer during the notching process. On the other hand, when the content of the rubber-based binder in the anode electrode 100 as a whole is excessive, electrical resistance may increase and battery characteristics may deteriorate. Accordingly, when the content of the rubber-based binder included in the first anode mixture layer 21, which is a lower layer, is adjusted to be relatively high compared to the content of the rubber-based binder included in the second anode mixture layer 22, which is a lower layer, the occurrence of the above-described problems may be substantially alleviated and the content of the rubber-based binder in the anode 100 may be reduced as a whole, so that an increase in electrical resistance may also be alleviated. Therefore, when the content relationship of the rubber-based binder for each anode mixture layer is applied as described above, the anode 100 having a multilayer may have excellent flexibility, adhesion, and the like, so that problems such as electrode detachment during the process or cracking during the charging/discharging process may be substantially alleviated, and low-resistance characteristics may also be secured.

A ratio of a loading weight (LW) of the first anode mixture layer 21 and the second anode mixture layer 22 may be about 2:8 to about 8:2. In addition, the loading weight of the first anode mixture layer 21 may be about 1.5 to about 9.5 mg/cm², and the loading weight of the second anode mixture layer 22 may be about 1.5 to about 9.5 mg/cm². The loading weight (LW) means that an amount of the anode mixture layer 20 formed on the anode current collector 10, that is, a layer containing an active material, a binder, a conductive material, and the like, is formed on the anode current collector 10, is expressed in units of weight per area. In this case, the area is based on an area of the anode current collector 10, and the weight is based on a weight of the entire anode mixture layer 20 formed thereon. When a value, a ratio, and the like of the loading weight (LW) of the first anode mixture layer 21 and the second anode mixture layer 22 are within the above-described range, an anode 100 with a multilayer structure having excellent capacity characteristics, lifespan characteristics, and fast charging characteristics may be provided.

A method of manufacturing the anode 100 for a lithium secondary battery is not particularly limited. For example, an anode slurry containing a first solvent, a first silicon-based active material, a first conductive material, and the like, may be applied on the anode current collector 10 by a method such as bar coating, casting, or spraying and dried at about 70 to about 100° C. to form a first anode mixture layer, and an anode slurry containing a second solvent, a second silicon-based active material, a second conductive material, and the like, on the first anode mixture layer 21, by a method such as bar coating, casting, or spraying and dried at about 70 to about 100° C. to form a second anode mixture layer 22.

The solvent may be, for example, dimethyl sulfoxide (DMSO), isopropyl alcohol, N-methylpyrrolidone (NMP), acetone, or water. It is sufficient that the amount of the solvent used is sufficient to dissolve or disperse an active material, a conductive material, and a binder in consideration of an application thickness, and manufacturing yield of a composition for forming an anode mixture layer, and then to have viscosity that can exhibit excellent thickness uniformity when applied to form the anode mixture layer.

### Lithium Secondary Battery

A lithium secondary battery according to an embodiment may include an anode electrode 100 for a lithium secondary battery according to any one of the above-described embodiments. Specifically, the lithium secondary battery may include an anode 100 and a cathode for a lithium secondary battery according to any one of the above-described embodiments, and may or may not optionally further include a separator interposed between the cathode and the anode.

The cathode may include lithium-transition metal complex oxide as an active material. Specifically, the lithium-transition metal complex oxide may be an NCM-based cathode active material expressed by a chemical formula LiₓNiₐCo_{b}Mn_{c}O_{y} (0<x≤1.1, 2≤y≤2.02, 0<a<1, 0<b<1, 0<c<1, 0<a+b+c≤1), or a lithium iron phosphate (LFP)-based cathode active material represented by a chemical formula LiFePO₄.

The separator may include a porous polymer film formed of polyolefin-based polymers such as ethylene homopolymer, propylene homopolymer, ethylene/butene copolymer, ethylene/hexene copolymer, and ethylene/methacrylate copolymer. In addition, the separator may include a non-woven fabric formed of high-melting point glass fiber, polyethylene terephthalate fiber, and the like.

The lithium secondary battery has excellent high capacitance characteristics, lifespan characteristics, and fast charging characteristics, and thus can be very useful as a power source for electric vehicles (EV).

### EXAMPLES AND COMPARATIVE EXAMPLES

### 1. Manufacturing Anode and Secondary Battery

### 1) Manufacturing an Anode

### (1) Reference Examples 1 to 2

In order to confirm the results of electrode Raman analysis according to the type of conductive material, an anode mixture layer having a single-layer structure having the composition shown in Table 1 below was prepared, and Raman spectroscopic analysis was performed thereon to determine whether A_{RBM}/A_{G} values and RBM peaks were observed, and whether G-band splitting was observed, and then the results thereof were shown in Table 1 below.

An area (A_{RBM}) of the RBM peak area and an area (A_{G}) of the G-band peak area were calculated using a Resolutions Pro program. In this case, the area (A_{RBM}) of the RBM peak area was derived from a baseline using a 2nd derivative method, and then calculated by integrating the area derived by fitting a peak corresponding to wavenumbers of 106 cm⁻¹, 123 cm⁻¹, and 201 to 234 cm⁻¹ with a Gaussian curve, and the area (A_{G}) of the G-band peak area was calculated using the same method as described above for a peak corresponding to wavenumbers of 1215 cm⁻¹, 1565 cm⁻¹, and 1600 to 1745 cm⁻¹. In addition, Raman spectroscopic analysis was conducted under the following conditions: wavelength: 532 nm, magnification: 50 times, grating resolution: 1800 mm/l, laser power: 5%, and the number of scans: 10.

Meanwhile, a graphite-based conductive material in which neither the RBM peak nor the G-band splitting appears during Raman spectroscopy analysis as a conductive material (see FIG. 2A); and carbon nanotubes (see FIG. 2B) showing both RBM peak and G-band splitting during Raman spectroscopy analysis were applied differently for each reference example.

TABLE 1

| | | | Conductive material | | | | |
|---|---|---|---|---|---|---|---|
| | | | RBM peak | | | | |
| | Silicon-based | | and whether | | | | Whether |
| | active material | | G-band | | RBM peakl | | G-band |
| | | content | splitting | content | | Whether it | splitting |
| | Type | (wt %) | is observed | (wt %) | A_{RBM}/A_{G} | is observed | is observed |
| Reference | SiC | 2 | ◯ | 0.1 | 0.045 | ◯ | ◯ |
| example 1 | | | | | | | |
| Reference | SiC | 2 | X | 3 | 0.001 | X | X |
| example 2 | | | | | | | |

Referring to Table 1 above, during Raman spectroscopic analysis of an anode mixture layer (Reference Example 1) containing carbon nanotubes in which both the RBM peak and G-band splitting are observed, the A_{RBM}/A_{G} value was 0.045, which was included within a range of 0.03 to 0.06, so that it was confirmed that a RMB peak was observed and G-band splitting was observed (see FIG. 3A). On the other hand, in the case of an anode mixture layer (Reference Example 2) containing a graphite-based conductive material in which neither the RBM peak nor the G-band splitting is observed, the A_{RBM}/A_{G} value was 0.001, which was included within a range of 0.001 to 0.02, so that it was confirmed that a RMB peak is not observed and G-band splitting was not also observed.

Considering these results, it is determined that whether the RBM peak and G-band splitting are observed in the Raman spectrum obtained from the surface of the anode mixture layer may differ depending on the type of conductive material included in the anode mixture layer.

### (2) Examples and Comparative Examples

A first anode slurry including a carbon-based active material, a first silicon-based active material, a binder, and a first conductive material; and a second anode slurry including a carbon-based active material, a second silicon-based active material, a binder, and a second conductive material were manufactured, respectively. Thereafter, by simultaneously applying the first anode slurry and the second anode slurry on a copper foil, which is an anode current collector, and then drying the same at 80° C., an anode for a lithium secondary battery having a multilayer structure including a first anode mixture layer formed on the anode current collector; and a second anode mixture layer formed on the first anode mixture layer was manufactured. A ratio of a loading weight (LW) of the first anode mixture layer and the second anode mixture layer was applied at 5:5.

In this case, SiOx (0<x<2) and SiC were applied differently as the first silicon-based active material and the second silicon-based active material according to the examples and comparative examples, as shown in Table 1 below, a graphite-based conductive material that has a Raman R value of 0.15 according to Equation 1 below and illustrates neither the RBM peak nor the G-band splitting during Raman spectroscopy analysis as the first conductive material and the second conductive material and carbon nanotubes that have a Raman R value of 0.07 and illustrate both the RBM peak and G-band splitting during Raman spectroscopy analysis were applied differently as the examples and comparative examples, and the remainder of the artificial graphite was used as a carbon-based active material, and carboxymethyl cellulose (CMC) and styrene-butadiene rubber (SBR) were used as a binder.

$$Raman R = {A}_{D} / {A}_{G} \qquad [ Equation 1 ]$$

In Equation 1, A_{D} is a peak area value of an absorption region of 1330 to 1380 cm⁻¹, and A_{G} is a peak area value of an absorption region of 1550 to 1625 cm⁻¹.

In this case, the peak area was calculated using a Resolutions Pro program, and specifically, a base line was derived using a 2^{nd} derivative method, and then an area derived by fitting a peak corresponding to a wave number of each region with a Gaussian curve was integrated and calculated. In addition, Raman spectroscopic analysis was conducted under the following conditions: wavelength: 532 nm, magnification: 50 times, grating resolution: 1800 mm/l, laser power: 5%, and the number of scans: 10.

Meanwhile, the contents of carboxymethylcellulose (CMC) and styrene-butadiene rubber (SBR), which are binders in the first anode mixture layer, were 1.2% and 2.4% by weight, respectively, and the contents of carboxymethyl cellulose (CMC) and styrene-butadiene rubber (SBR), which are binders in the second anode mixture layer, were 1.2% by weight and 0.6% by weight, respectively. The content of the first silicon-based active material and the first conductive material in the first anode mixture layer, and the content of the second silicon-based active material and the second conductive material in the second anode mixture layer were applied as shown in Table 1 below according to Examples and Comparative Examples.

TABLE 2

| | First anode mixture layer (lower layer) | | | | | Second anode mixture layer (upper layer) | | | | |
|---|---|---|---|---|---|---|---|---|---|---|
| | | | First conductive | | | | | Second conductive | | |
| | | | material | | | | | material | | |
| | | | | | Whether | | | | | Whether |
| | First silicon-based | | | | RBM and | Second silicon-based | | | | RBM and |
| | active material | | | Raman | G-band | active material | | | Raman | G-band |
| | | Content | content | R value | splitting | | Content | Content | R value | splitting |
| | Type | (wt %) | (wt %) | (A_{D}/A_{G}) | are observed | Type | (wt %) | (wt %) | (A_{D}/A_{G}) | are observed |
| Example 1 | SiC | 4 | 3 | 0.15 | X | SiC | 16 | 0.1 | 0.07 | ◯ |
| Example 2 | SiOₓ | 4 | 3 | 0.15 | X | SiC | 18 | 0.1 | 0.07 | ◯ |
| Example 3 | SiC | 4 | 3 | 0.15 | X | SiOₓ | 36 | 0.15 | 0.07 | ◯ |
| Example 4 | SiOₓ | 8 | 3 | 0.15 | X | SiC | 16 | 0.1 | 0.07 | ◯ |
| Comparative | SiC | 4 | 0.1 | 0.07 | ◯ | SiC | 16 | 3 | 0.15 | X |
| Example 1 | | | | | | | | | | |
| Comparative | SiC | 4 | 3 | 0.07 | ◯ | SiC | 16 | 0.1 | 0.07 | ◯ |
| Example 2 | | | | | | | | | | |

### 2) Secondary Battery Manufacturing

A cathode was manufactured by applying and drying a cathode slurry containing an NCM-based active material, which is a lithium-transition metal composite oxide, on an aluminum foil, and a secondary battery cell manufactured by interposing a polyolefin separator between the cathode and the anode manufactured as disclosed above was inserted into a pouch for a secondary battery, and then an electrolyte dissolved with LiPF₆ Of 1M was injected in a solvent mixed with ethylene carbonate (EC) and diethyl carbonate (DEC) into the pouch for the secondary battery, then sealed to manufacture a pouch-type lithium secondary battery.

### 2. Secondary Battery Evaluation

### 1) Room Temperature (25° C.) Capacity Retention Rate

For the secondary battery manufactured as disclosed above, lifespan characteristics evaluation within a DOD94 (SOC4-98) range was conducted in a chamber maintained at a temperature of 25° C. The secondary battery was charged at 0.3 C to a voltage corresponding to SOC98 under constant current/constant voltage (CC/CV) conditions, then cut off at 0.05 C, and then discharged at 0.3 C to a voltage corresponding to SOC4 under constant current (CC) conditions, and a discharge capacity thereof was measured. After repeating the operations described above for 500 cycles, the discharge capacity retention rate was measured as a % as compared to an initial discharge capacity, and the capacity retention rate when evaluating lifespan characteristics at room temperature was measured, and the results were shown in Table 2 below.

2) Rapid charging capacity retention rate

For the secondary battery manufactured as described above was charged to reach DOD72 within 25 minutes according to step charging methods (C-rate: 2.5 C/2.25 C/2.0 C/1.75 C/1.5 C/1.25 C/1.0 C/0.75 C/0.5 C), and then discharged at 1/3 C. The charging/discharging was performed as 1 cycle, and 100 cycles are repeated with a waiting time of 10 minutes between the charging/discharging cycles. Then, a discharge capacity retention rate compared to an initial discharge capacity was measured in % to determine a rapid charge capacity retention rate, and the results were shown in Table 2 below.

TABLE 3

| | Room temperature capacity | Rapid charging capacity |
|---|---|---|
| | retention rate(%) | retention rate (%) |
| Example 1 | 91.6 | 90.5 |
| Example 2 | 90.2 | 89.6 |
| Example 3 | 87.1 | 82.6 |
| Example 4 | 85.7 | 80.5 |
| Comparative | — | 73.5 |
| Example 1 | | |
| Comparative | — | 70.3 |
| Example 2 | | |

Referring to Tables 1 to 3, it was found that room temperature lifespan and rapid charging characteristics were improved when the scope of the present disclosure was satisfied, as in Examples 1 and 2. It was confirmed that the secondary battery of Example 3 had a room temperature capacity retention rate and a rapid charging capacity retention rate that were inferior to those of the secondary batteries of Examples 1 and 2. Specifically, in the case of Example 3, as the second anode mixture layer, which is an upper layer, includes an excessive amount of silicon-based active material, so the excessive amount of silicon-based active material causes a side reaction with an electrolyte, it was confirmed that the performance thereof was inferior as compared to Examples 1 and 2.

In addition, it was confirmed that the secondary battery of Example 4 had a room temperature capacity retention rate and a rapid charging capacity retention rate that were inferior to those of the secondary batteries of Examples 1 and 2. Specifically, as the first anode mixture layer contained an excessive amount of silicon-based active material, it was confirmed that the performance was inferior to Examples 1 and 2 due to interruption of the conductive path due to volume contraction and expansion of the excess silicon-based active material.

Meanwhile, it was confirmed that the secondary battery of Comparative Example 1 had a fast charging capacity retention rate inferior to that of the secondary batteries of Examples 1 and 2. Specifically, in the case of Comparative Example 1, it was confirmed that the performance was inferior to Examples 1 and 2 since the second anode mixture layer includes an excessive amount of silicon-based active material and a conductive material with a relatively high Raman R value, and due to interruption of the conductive path due to volume expansion of the second silicon-based active material.

In addition, it was confirmed that the secondary battery of Comparative Example 2 had an inferior fast charging capacity retention rate. Specifically, it was confirmed that the performance was inferior to Examples 1 and 2 to which a first conductive material (R=0.15) having a relatively large Raman R value because the conductive path was sufficiently formed, but the pores in the electrode were reduced due to excellent dispersibility, using a second conductive material (R=0.07) having a relatively low Raman R value was applied.

In other words, when the characteristics of the silicon-based active material, conductive material, and the like, are appropriately adjusted differently in consideration of the characteristics required for each upper and lower layer in an anode having a multilayer structure, it is determined that an anode for a high-capacity secondary battery with both excellent lift span characteristics and rapid charging characteristics may be provided.

As set forth above, in an embodiment of the disclosed technology, a high-capacity anode for a secondary battery that can alleviate the effects of the expansion/contraction of the volume of the silicon-based active material during charging/discharging by including silicon-based active materials and conductive materials having different characteristics for each upper and lower layer, and has excellent high-temperature lifespan characteristics and fast charging characteristics, may be provided.

In another embodiment of the disclosed technology, an anode for a lithium secondary battery that can relatively reduce an amount of electrolyte consumption and improve capacity characteristics by applying different silicon-based active material content, conductive material characteristics, and the like, for each upper and lower layer, may be provided.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An anode for a secondary battery, comprising:
an anode current collector;
a first anode mixture layer formed on at least one surface of the anode current collector, and including a first silicon-based active material and a first conductive material; and
a second anode mixture layer formed on the first anode mixture layer, and including a second silicon-based active material and a second conductive material,
wherein a content of the first silicon-based active material in the first anode mixture layer is lower than a content of the second silicon-based active material in the second anode mixture layer, and
a Radial Breathing Mode (RBM) peak is observed in a Raman spectrum obtained from a surface of the second anode mixture layer.

2. The anode for a secondary battery of claim 1, wherein G-band splitting is observed in the Raman spectrum obtained from the surface of the second anode mixture layer.

3. The anode for a secondary battery of claim 1, wherein the first silicon-based active material and the second silicon-based active material include at least one of SiOₓ (0<x<2) and SiC, respectively.

4. The anode for a secondary battery of claim 1, wherein the content of the first silicon-based active material in the first anode mixture layer is 0.1 to 5% by weight.

5. The anode for a secondary battery of claim 1, wherein the content of the second silicon-based active material in the second anode mixture layer is 6 to 35% by weight.

6. The anode for a secondary battery of claim 1, wherein the first conductive material comprises a graphite-based conductive material, and
the second conductive material comprises a CNT-based conductive material.

7. The anode for a secondary battery of claim 1, wherein the first conductive material is any one selected from artificial graphite, natural graphite, graphene, carbon black, acetylene black, Ketjen black, Super P, hard carbon, and combinations thereof.

8. The anode for a secondary battery of claim 1, wherein the second conductive material is any one selected from multi-walled carbon nanotubes (MWCNT), single-walled carbon nanotubes (SWCNT), thin-film carbon nanotubes (TWCNT), and combinations thereof.

9. The anode for a secondary battery of claim 1, wherein a content of the first conductive material in the first anode mixture layer is higher than a content of the second conductive material in the second anode mixture layer.

10. The anode for a secondary battery of claim 9, wherein the content of the first conductive material in the first anode mixture layer is 0.3 to 5% by weight, and the content of the second conductive material in the second anode mixture layer is 0.01 to 0.25% by weight.

11. The anode for a secondary battery of claim 1, wherein a particle diameter (D50) of the first conductive material is 1 to 10 μm.

12. The anode for a secondary battery of claim 1, wherein a length of the second conductive material is 5 to 100 μm.

13. An anode for a lithium secondary battery, comprising:
an anode current collector;
a first anode mixture layer formed on at least one surface of the anode current collector, and including a first silicon-based active material and a first conductive material; and
a second anode mixture layer formed on the first anode mixture layer, and including a second silicon-based active material and a second conductive material,
wherein a content of the first silicon-based active material in the first anode mixture layer is lower than a content of the second silicon-based active material in the second anode mixture layer, and
the first conductive material has a Raman R value according to Equation 1 below which is greater than that of the second conductive material,
Raman R=A_{D}/A_{G} [Equation 1]
where A_{D} is a peak area value of an absorption region from 1330 to 1380 cm⁻¹, and A_{G} is a peak area value of an absorption region from 1550 to 1625 cm⁻¹.

14. The anode for a lithium secondary battery of claim 13, wherein the content of the first silicon-based active material in the first anode mixture layer is 0.1 to 5% by weight.

15. The anode for a lithium secondary battery of claim 13, wherein the content of the second silicon-based active material in the second anode mixture layer is 6 to 35% by weight.

16. The anode for a lithium secondary battery of claim 13, wherein the Raman R value of the first conductive material is 0.11 to 0.5, and the Raman R value of the second conductive material is 0.001 to 0.1.

17. The anode for a lithium secondary battery of claim 13, wherein the first conductive material is any one selected from artificial graphite, natural graphite, graphene, carbon black, acetylene black, Ketjen black, Super P, hard carbon, and combinations thereof.

18. The anode for a lithium secondary battery of claim 13, wherein the second conductive material is any one selected from multi-walled carbon nanotubes (MWCNT), single-walled carbon nanotubes (SWCNT), thin-film carbon nanotubes (TWCNT), and combinations thereof.

19. The anode for a lithium secondary battery of claim 13, wherein the content of the first conductive material in the first anode mixture layer is higher than the content of the second conductive material in the second anode mixture layer.

20. A lithium secondary battery comprising the anode of claim 1.
